(19) United States
(12) Patent Application Publication
(10) Pub. No.: US 2017/0365285 A1
(43) Pub. Date: Dec. 21, 2017

(54) HARD DISK CIRCUIT WITH DIRECT CONNECTION TO PREAMP

(71) Applicant: NITTO DENKO CORPORATION, Osaka (JP)

(72) Inventors: Alex N.E. Cayaban, Osaka (JP); Hitoki KANAGAWA, Osaka (JP); Yukimasa KAWATO, Osaka (JP)

(73) Assignee: NITTO DENKO CORPORATION, Osaka (JP)

(21) Appl. No.: 15/609,166

(22) Filed: May 31, 2017

Related U.S. Application Data
(60) Provisional application No. 62/351,517, filed on Jun. 17, 2016.

(51) Int. Cl. G11B 5/48; G11B 5/09

(52) U.S. Cl. CPC G11B 5/4853; G11B 5/486; G11B 5/09; G11B 5/4833

(57) ABSTRACT

A head stack assembly (HSA) includes: a preamp having first contacts disposed on a first side and second contacts disposed on a second side which is opposite to the first side; a main actuator circuit disposed proximate the first side of the preamp and having Contacts configured to be electrically connected to the first contacts of the preamp; and a flexure/suspension circuit disposed proximate the second side of the preamp and having flexure/suspension circuit contacts configured to be directly electrically connected to the second contacts of the preamp.

### CROSS-REFERENCE TO RELATED APPLICATION

This application claims the benefit of U.S. Provisional Application No. 62/351,157, filed Jun. 17, 2016, the disclosure of which is incorporated herein in its entirety by reference.

### BACKGROUND

### 1. Field

Apparatuses consistent with exemplary embodiments relate to hard disk drive (HDD) technology, and more specifically, to an HDD suspension, flexure/suspension circuit and the connection to the preamp which is mounted onto the main actuator circuit.

### 2. Description of the Related Art

Hard disk drives include flexures/suspension circuits which support the HDD in, for example, a computer. A flexure/suspension circuit is connected to a main actuator circuit, and provides an electrical connection between the main actuator circuit and the read-write head of the HHD. The flexure/suspension circuit consists of a steel layer and one or more intricately patterned copper foil layers with insulating material (for example, polyimide) which separate the conductive layers (for example, the copper and steel layers) from each other.

### SUMMARY

An exemplary embodiment is directed to methods and apparatuses providing direct connections between the flexure/suspension circuit(s) and one or more preamps. On the opposite end of the preamp(s), a separate interposer(s) may connect circuitry from the main actuator circuit to the preamp(s). This simplifies the main actuator circuit pad design connecting to the preamp(s).

### BRIEF DESCRIPTION OF THE DRAWINGS

The above and/or other aspects will become more apparent by describing certain exemplary embodiments, with reference to the accompanying drawings, in which:

FIG. 1 illustrates a related art the Head Stack Assembly (HSA).

FIGS. 2 and 3 illustrate an assembly according to an exemplary embodiment.

FIG. 4 illustrates connection circuits disposed between the preamp and the flexure/suspension circuits, according to an exemplary embodiment.

FIG. 5 illustrates the main actuator circuit, according to an exemplary embodiment.

FIG. 6 illustrates the main actuator circuit with the mounted preamp, according to an exemplary embodiment.

FIG. 7 is a top view of an example of the formed interposer circuit, according to an exemplary embodiment.

FIG. 8 illustrates a bottom view of the formed interposer circuit of FIG. 7, according to an exemplary embodiment.

FIG. 9 illustrates an overall view of the flexure/suspension circuit, according to an exemplary embodiment.

FIG. 10 illustrates a top surface of a portion of the flexure/suspension circuit, according to an exemplary embodiment.

FIG. 11 illustrates a bottom surface of the portion of the flexure/suspension circuit, according to an exemplary embodiment.

FIG. 12 illustrates a side view of an assembly, according to an exemplary embodiment.

FIGS. 13A and 13B illustrate solder connections, according to an exemplary embodiment.

FIG. 14 illustrates an electrically conductive tape to make electrical connection, according to an exemplary embodiment.

FIG. 15 illustrates wire-bondable pads formed on the main actuator circuit, according to an exemplary embodiment.

FIG. 16 illustrates wire-bondable pads of the formed interposer circuit, according to an exemplary embodiment.

FIG. 17 illustrates an assembly (ready for ultra-sonic tab bonding (USTB)) according to an exemplary embodiment.

FIG. 18 illustrates an assembly according to an exemplary embodiment.

FIG. 19 illustrates an assembly according to an exemplary embodiment.

FIG. 20 illustrates the assembly of FIG. 19 without a coverlay, according to an exemplary embodiment.

FIG. 21 illustrates a top view of a flat preamp interposer, according to an exemplary embodiment.

FIG. 22 illustrates a bottom view of the flat preamp interposer of FIG. 21, according to an exemplary embodiment.

FIG. 23 illustrates a bottom view of the flat preamp interposer of FIG. 21, according to an exemplary embodiment.

FIG. 24 illustrates a portion of a set of flexure/suspension circuits which may be edge-mounted, according to an exemplary embodiment.

FIG. 25 illustrates a conductive film which provides electrical connection, according to an exemplary embodiment.

FIG. 26 illustrates the flat preamp interposer attached to the main actuator circuit via the conductive layer, according to an exemplary embodiment.

FIG. 27 illustrates the preamp, according to an exemplary embodiment.

FIG. 28 illustrates a bottom view of the preamp, according to an exemplary embodiment.

FIG. 29 illustrates the preamp attached to the main actuator circuit via the preamp module, according to an exemplary embodiment.

FIG. 30 illustrates the flexure/suspension circuits edge-mounted to the preamp module, according to an exemplary embodiment.

FIG. 31 illustrates a top surface of the preamp, according to an exemplary embodiment.

FIGS. 32 and 33 illustrate an exemplary embodiment of the preamp.

FIGS. 34A and 34B illustrate an assembly of an exemplary embodiment and of related art, respectively.

FIGS. 35A and 35B illustrate a detailed assembly of an exemplary embodiment and of related art, respectively.

FIG. 36 illustrates the thermal simulation models of an exemplary embodiment and of the related art.

FIG. 37 illustrates the thermal simulation results.

FIG. 38 illustrates Dual stage actuator (DSA) lines formed in the main actuator circuit, according to an exemplary embodiment.

FIG. 39 illustrates the flexure/suspension circuits provided with the flaps to connect with the DSA lines, according to an exemplary embodiment.

FIG. 40 illustrates the solder bumps which electrically connect the DSA lines with the flexure/suspension circuits, according to an exemplary embodiment.

### DETAILED DESCRIPTION

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of exemplary embodiments. Thus, it is apparent that exemplary embodiments can be carried out without those specifically defined matters. Also, well-known functions or constructions are not described in detail since they would obscure exemplary embodiments with unnecessary detail.

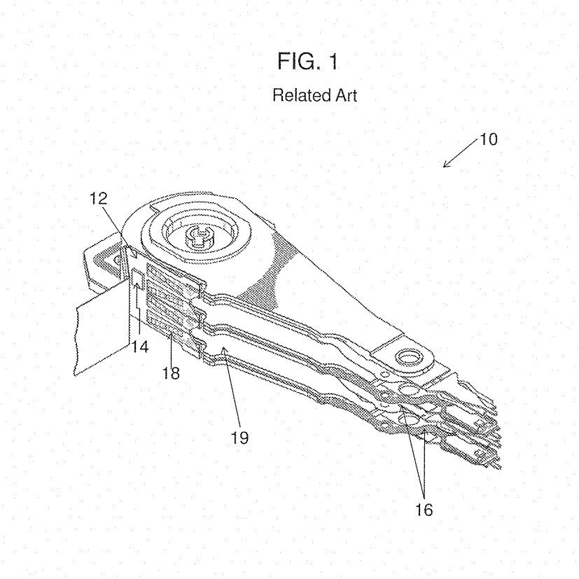

FIG. 1 illustrates a related art Head Stack Assembly (HSA) 10. It consists of the main actuator circuit 12 and a preamp 14 mounted to the main actuator circuit 12. Flexure/suspension circuits 16 are connected to pads 18 in the main actuator circuit 12. The main actuator circuit 12 and flexure/suspension circuits 16 are mounted to the E-block 19.

The preamp 14 is electrically connected to the main actuator circuit 12 via a series of conductive pads 18, for example, copper. The conductive path continues via a set of conductive pads on the other side of the preamp 14 and a set of flexure/suspension circuits 16 is connected to the conductive pads. That is, the main actuator circuit 12 is connected to both the preamp 14 and flexure/suspension circuits 16 and the related art does not provide direct connection of the flexure/suspension circuits to the preamp.

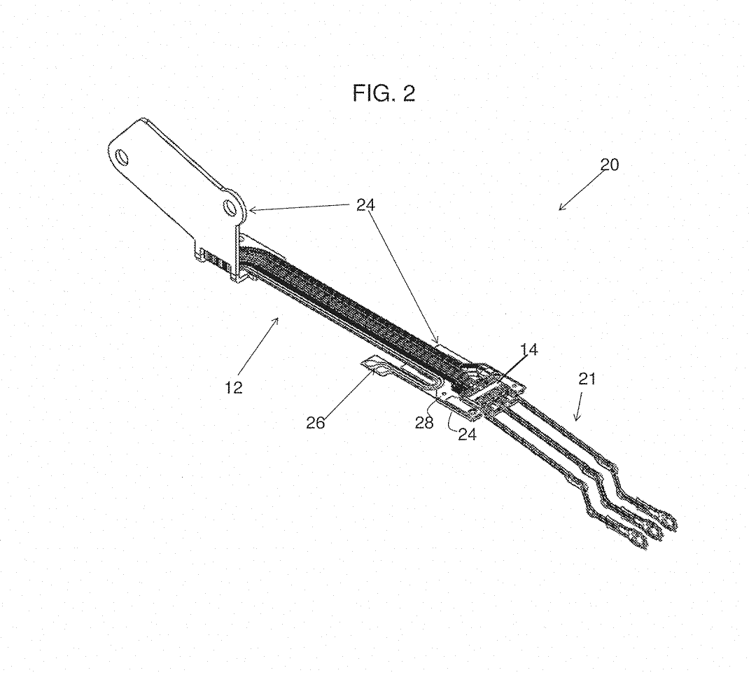

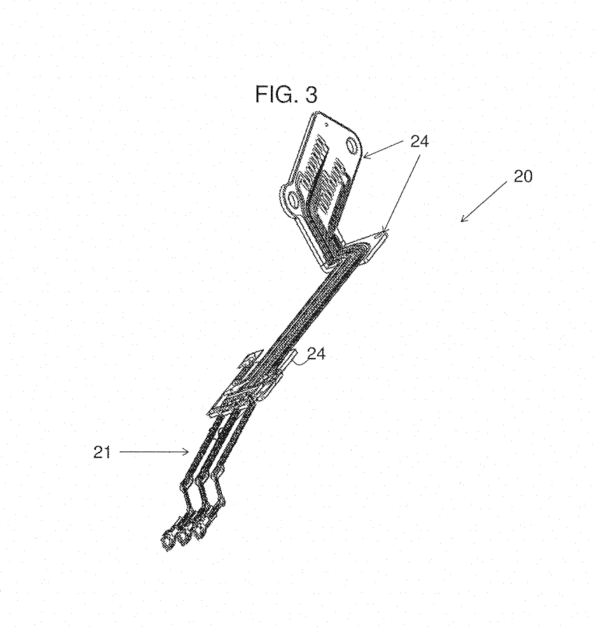

FIGS. 2 and 3 illustrate an assembly 20 including a main actuator circuit 12 and flexure/suspension circuit or circuits 21, according to an exemplary embodiment. Stiffeners 24 may be formed of aluminum or steel, but this is not limiting. For example, other materials may be used as, for example, polyimide.

A first dielectric layer 28 is disposed on the stiffener 24 and a conductive material 26, such as copper, is disposed on the first dielectric layer 28 and provides a set of contacts, conductive traces, and/or conductive pads. A second dielectric layer may be disposed to cover portions of the conductive material 26.

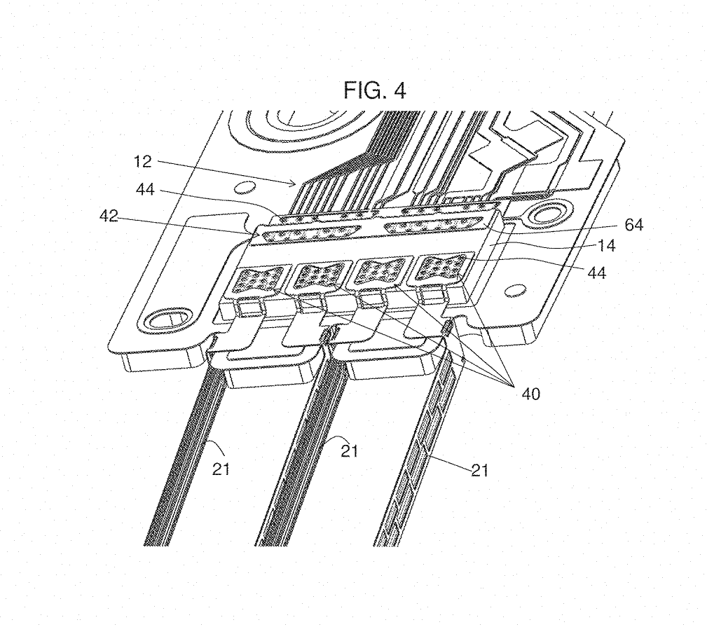

FIG. 4 illustrates connection circuits 40, according to an exemplary embodiment, which provide connection between the preamp 14 and the flexure/suspension circuits 21, and an interposer circuit 42 having a body 64 disposed on the preamp 14 on the opposite side of the connection circuits 40, to provide connection between the preamp 14 and the main actuator circuit 12. The electrical connection between the elements may be achieved by solder bumps 44, as described in greater detail below. As seen in FIG. 4, the flexure/suspension circuits 21 are directly connected to the preamp 14, unlike the apparatus of the related art which exhibits undesirable impedance discontinuities at the extra solder joints. Although FIG. 4 illustrates one interposer and four flexure/suspension circuits, a greater number of interposers and a greater or smaller number of flexure/suspension circuits may be implemented.

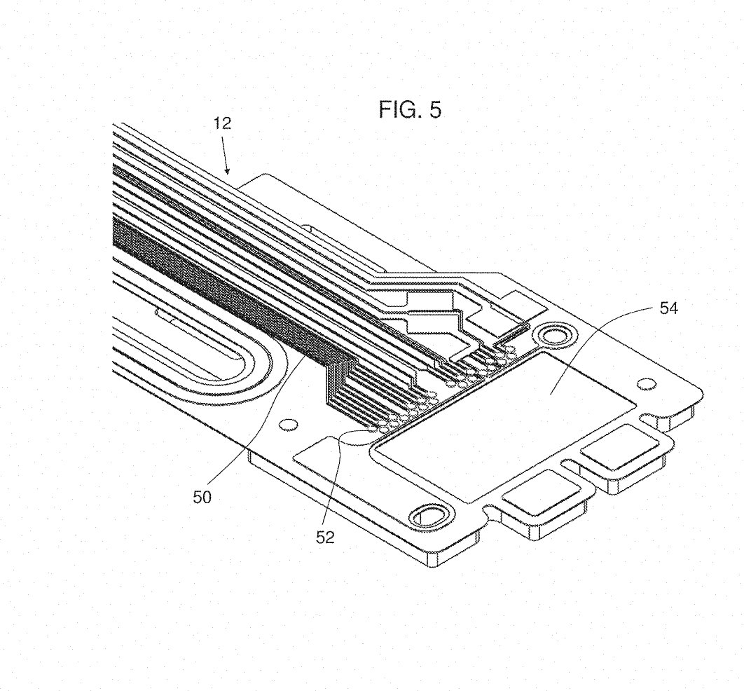

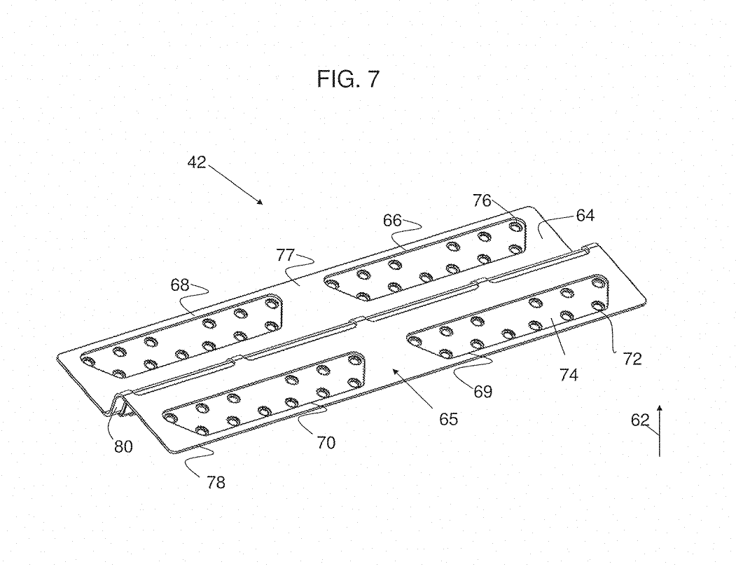

FIG. 5 illustrates the main actuator circuit 12 having a circuitry 50 terminated at pads 52, e.g., contacts, according to an exemplary embodiment. The pads 52 connect to a single interposer circuit 42 (FIG. 7), and, thus, the size and shape of the main actuator circuit can be simplified, thereby making the main actuator circuit easier and cheaper to manufacture. An opening 54 may be formed in the main actuator circuit 12 to accommodate the preamp 14. According to the present exemplary embodiment only one set of pads 52 for a single interposer circuit is shown, but this is not limiting.

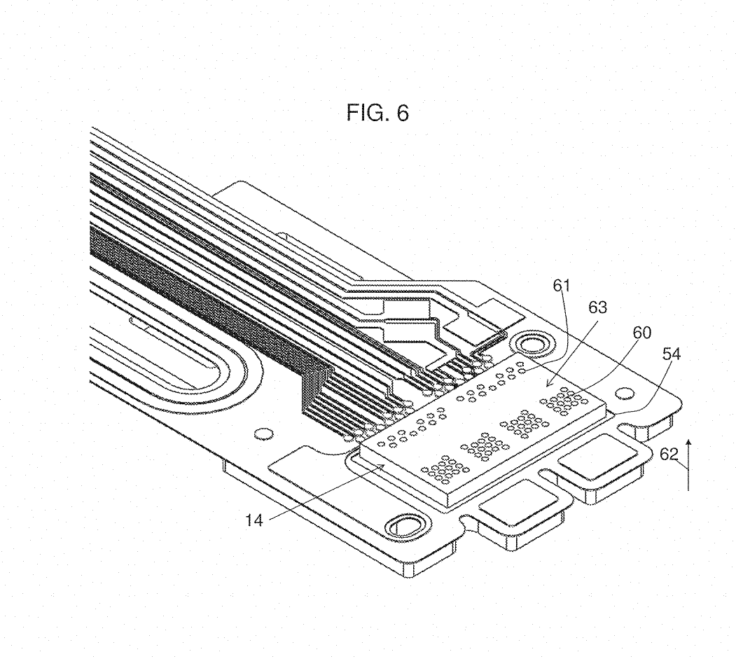

FIG. 6 illustrates the preamp 14, according to an exemplary embodiment, which is mounted into the opening 54, so that preamp contacts 60 and 61, e.g., conductive pads, are disposed on a top surface 63 and are facing in an upward direction 62. Since the body of the preamp 14 is mounted directly onto the metal, the heat dissipation may be improved.

FIG. 7 is a top view of an example of the formed interposer circuit 42, according to an exemplary embodiment, which has the body 64, formed of metal, such as stainless steel, having a top surface 65 and contact sets 66, 68, 69, and 70. Each contact set has openings 72 surrounded by a dielectric layer 74, such as polyimide. A conductive material 76, such as copper, is exposed on the inner walls of the openings 72, to provide electric conductivity.

The body 64 of the formed interposer circuit 42 has a step-up shape in which the contact sets 66 and 68 are disposed on a lower plate 77 for connecting to the circuitry 50 of the main actuator circuit 12, and the contact sets 69 and 70 are disposed on an upper plate 78 for connecting to the flexure/suspension circuits 21.

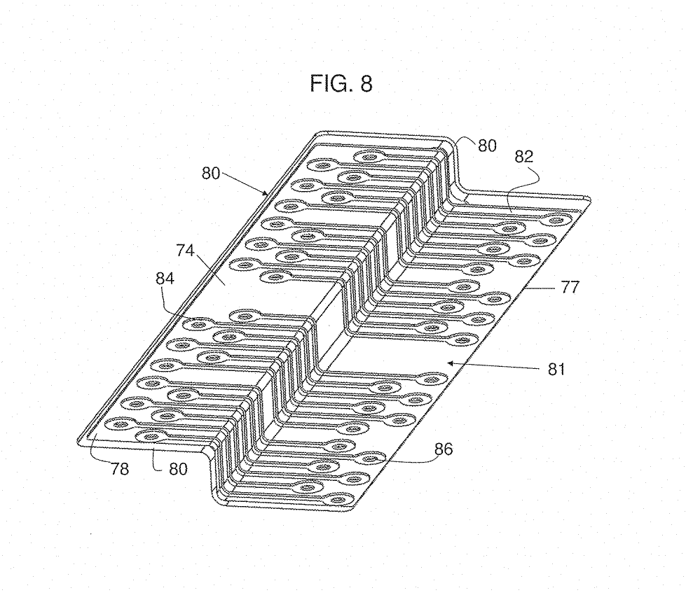

FIG. 8 illustrates a bottom view of the formed interposer circuit 42 of FIG. 7, according to an exemplary embodiment. The step-up shape of the interposer circuit 42 is held in place by the body 64 formed of metal, for example, steel, having a boundary portion 80 that protrudes from the top surface 65 so that the boundary portion 80 overhangs the dielectric layer 74, as seen at a bottom surface 81.

A circuitry 82, e.g., copper traces, is disposed on the dielectric layer 74 at the bottom surface 81 of the interposer circuit 42 for providing electrical connection between conductive pads 84 disposed on the upper plate 78 and conductive pads 86 disposed on the lower plate 77. However, this is only an example, and an exemplary embodiment is not limited thereto.

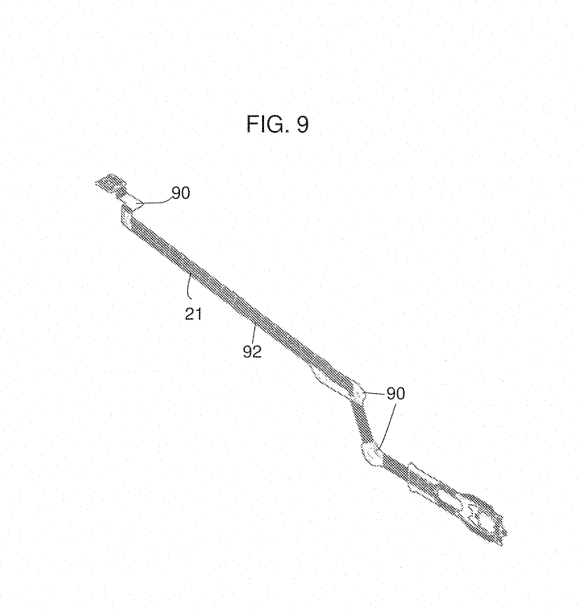

FIG. 9 illustrates an overall view of the flexure/suspension circuit 21 which has body members 90 formed of, for example, steel, which define a shape of and support the flexure/suspension circuit 21, according to an exemplary embodiment. A first dielectric material 92 and conductors extend in between the body members 90.

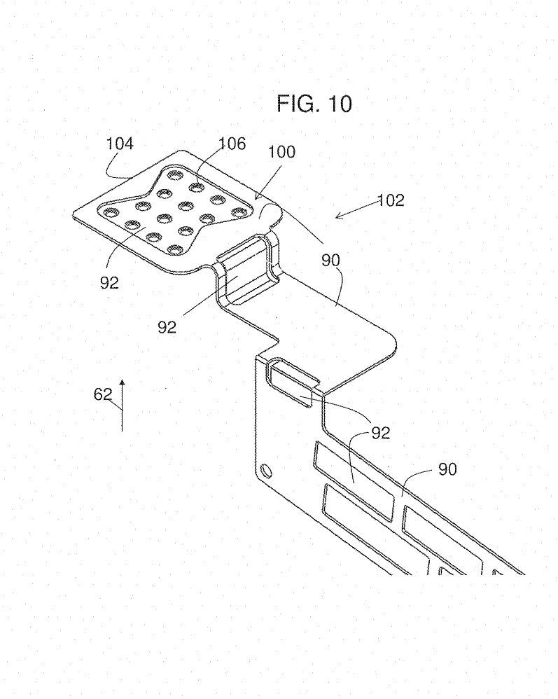

FIG. 10 illustrates a top surface 100 of a first portion 102 of the flexure/suspension circuit 21 that is connected to the preamp 14, according to an exemplary embodiment. A connecting portion 104 is formed at the end portion of the first portion 102 and includes the first dielectric material 92 disposed in the body member 90. Openings 106 are formed in the first dielectric material 92 of the connecting portion 104 and may include copper disposed on the inner walls, as described above, for providing electrical connectivity to the preamp contacts 60.

As seen in FIG. 10, the body members 90 provide a supporting frame for the first dielectric material 92 that extends in the supporting frame.

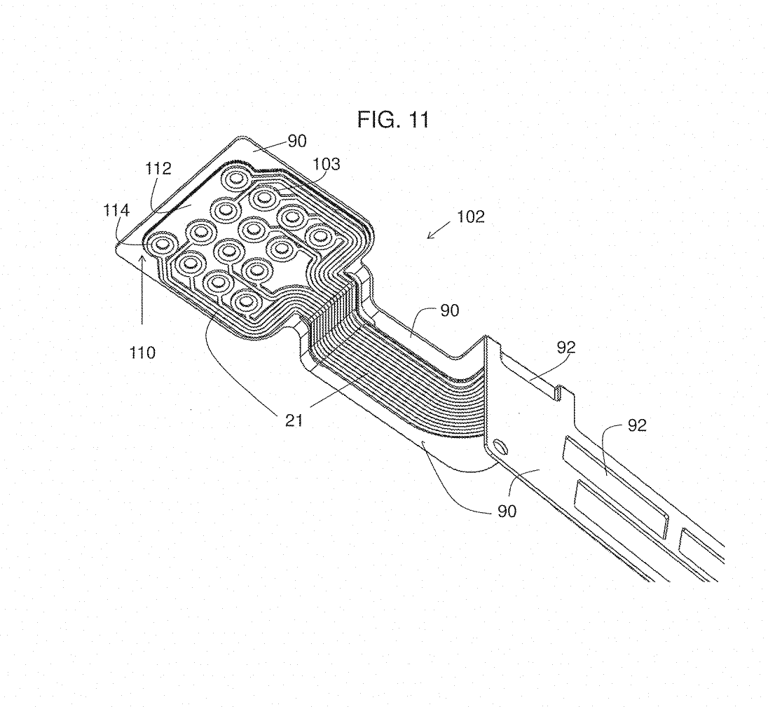

FIG. 11 illustrates a bottom surface 110 of the first portion 102 of the flexure/suspension circuit 21 having pads 103 for electrically connecting to the preamp 14, according to an exemplary embodiment. A second dielectric material 112 covers at least a portion of the copper circuitry 114. The flexure/suspension circuit described above is only an example, and an exemplary embodiment is not limited thereto.

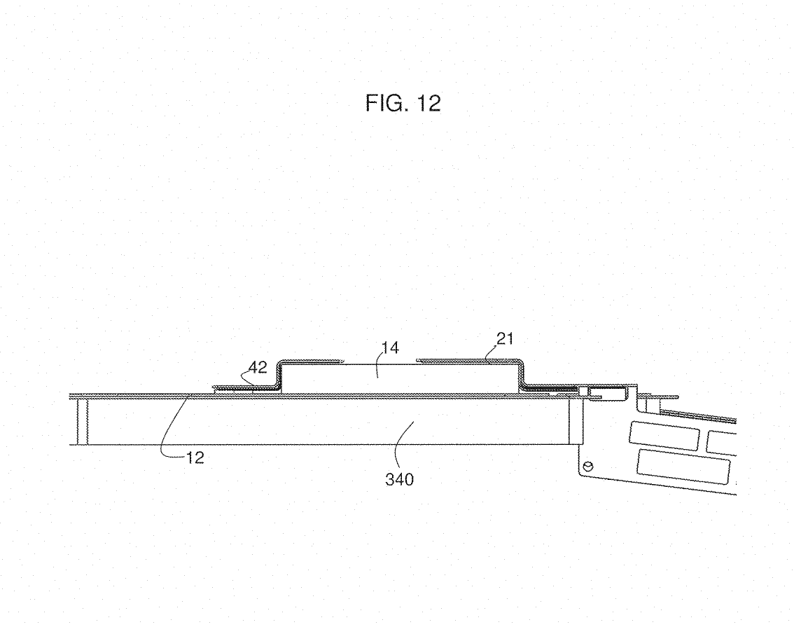

FIG. 12 illustrates a side view of an assembly including the formed interposer circuit 42, preamp 14, and flexure/suspension circuit 21, according to an exemplary embodiment.

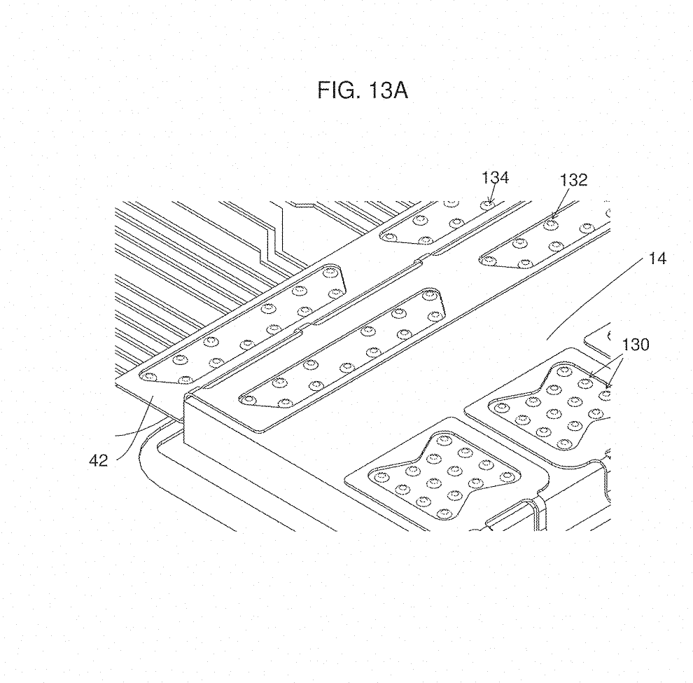

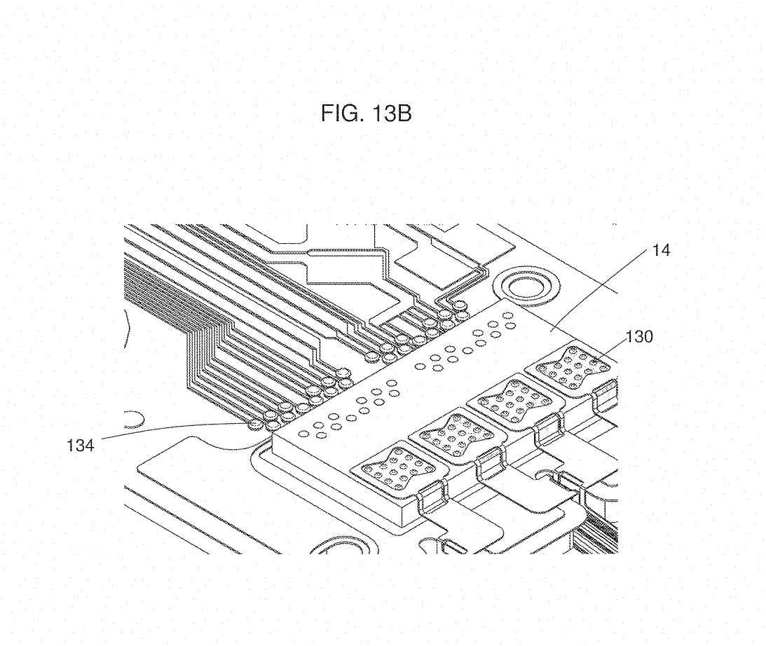

FIG. 13A illustrates solder connections 130 between the preamp 14 and flexure/suspension circuits 21, solder connections 132 between the preamp 14 and formed interposer circuit 42, solder connections 134 between the formed interposer circuit 42 and the main actuator circuit 12, according to an exemplary embodiment. For example, molten solder can be jetted into the openings in the interposer and into the openings of the flexure/suspension circuits connecting the conductive surfaces of the preamp to the conductive surfaces of the main actuator circuit and flexure/suspension circuits.

As shown in FIG. 13B, solder may be deposited as solder bumps 134 on the main actuator circuit 12, for example, by using solder paste, solder plating, or solder jetting methods known to those skilled in the art, prior to the interposer assembly. However, this is not limiting.

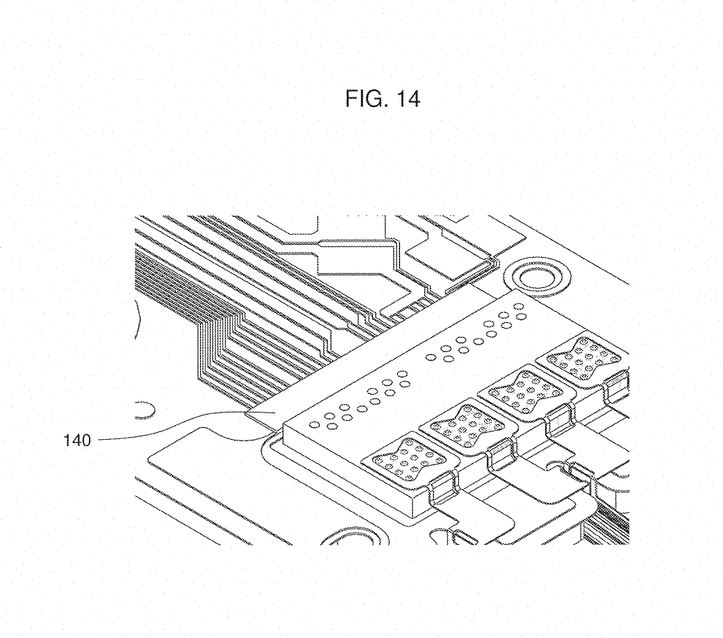

FIG. 14 illustrates an electrically conductive tape 140 which may be applied to the main actuator circuit prior to the formed interposer assembly to make electrical connection, according to an exemplary embodiment. For example, the conductive tape may be an anisotropic conductive film (ACF).

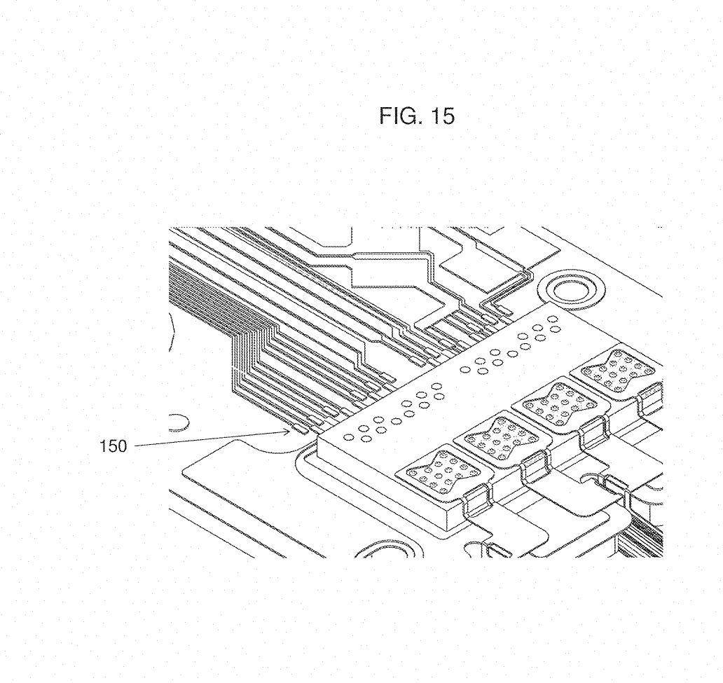

FIG. 15 illustrates rectangular wire-bondable pads 150 formed on the main actuator circuit, according to an exemplary embodiment. However, the shape of the wire-bondable pads 150 is not limited thereto.

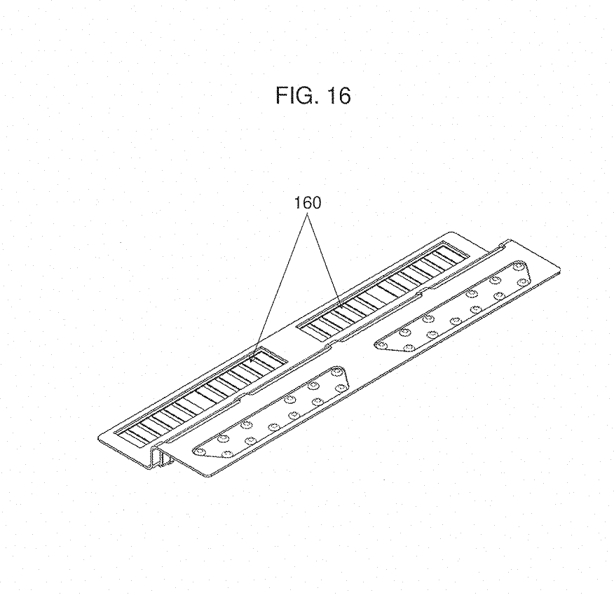

FIG. 16 illustrates rectangular wire-bondable pads 160 formed on the formed interposer circuit 42 that may provide the electrical connection between the main actuator circuit and the preamp 14, according to an exemplary embodiment. However, the shape of the wire-bondable pads 160 is not limited thereto.

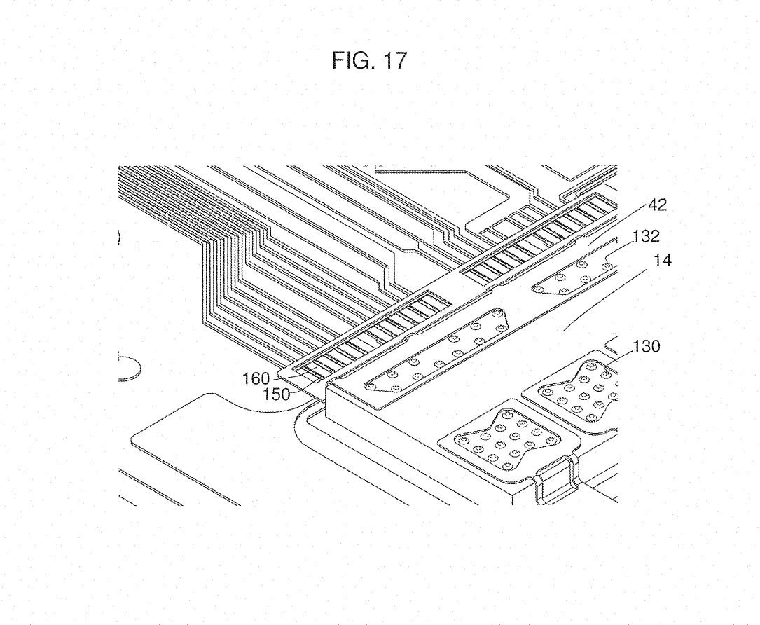

FIG. 17 illustrates an assembly in which the rectangular wire-bondable pads 150 of the main actuator circuit are connected to the rectangular wire-bondable pads 160 of the formed interposer circuit, while the raised portion of the formed interposer circuit 42 is connected via solder bumps 132 to the preamp 14, according to an exemplary embodiment.

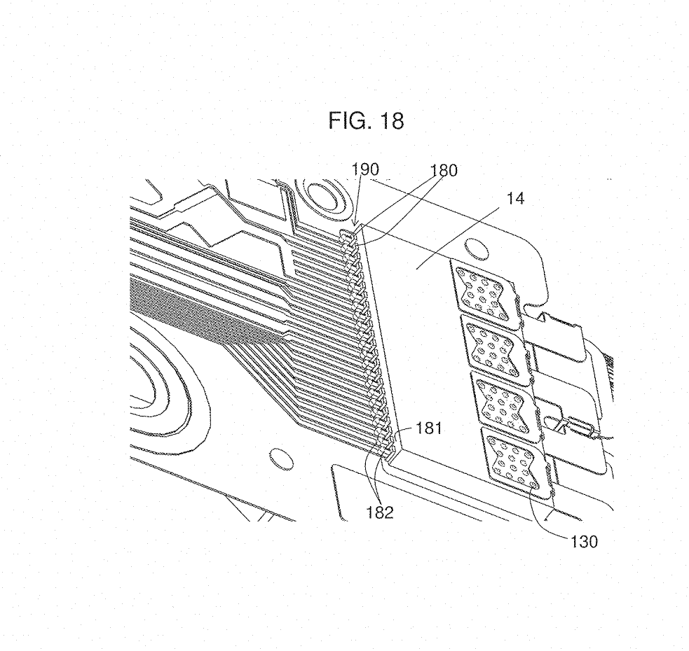

FIG. 18 illustrates an exemplary embodiment in which the preamp 14 is connected to the main actuator circuit 12 via a flat interconnected circuit 190, according to an exemplary embodiment. For example, the flat interconnected circuit may include a hybrid type, edge mount pads 180 disposed on a first side surface 181 of the preamp 14 that provide electrical connectivity to the main actuator circuit. For example, the edge mounted preamp pads 180 are connected to main actuator circuit pads 182 using solder, such as solder jet bond (SJB), solder paste, reflow, etc., but this is not limiting. The preamp 14 may be connected to the flexure/suspension circuits as described above with reference to exemplary embodiments.

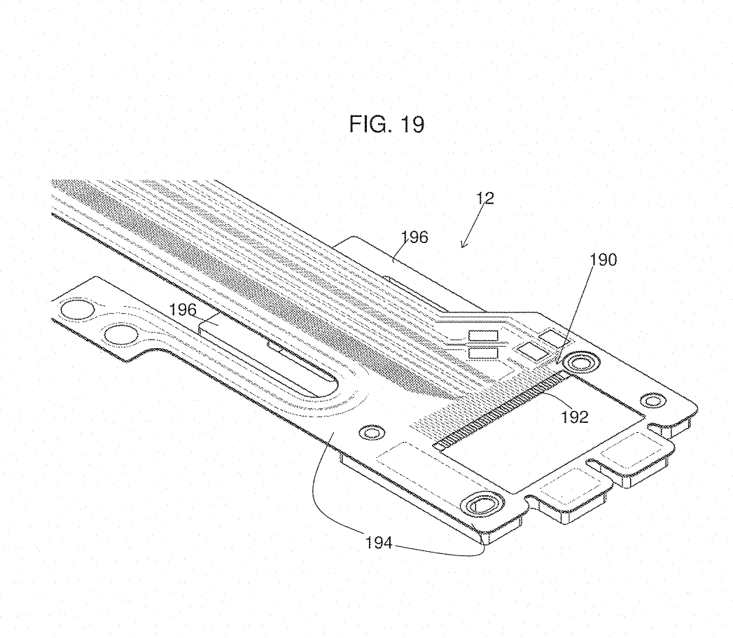

FIG. 19 illustrates an exemplary embodiment of an assembly in which the preamp 14 may be connected to the main actuator circuit 12 via the flat interconnected circuit 190 having exposed copper pads 192. A polyimide layer 194 is disposed on the aluminum stiffener 196 which supports the main actuator circuit circuitry.

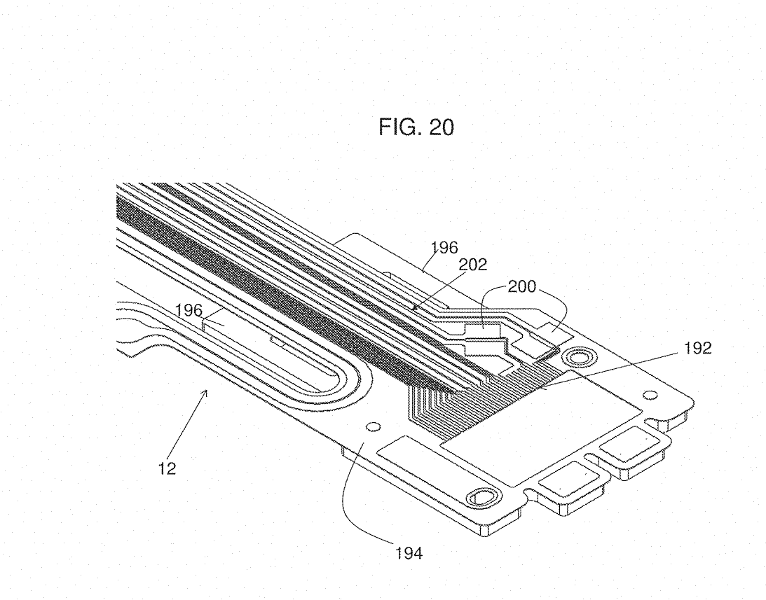

FIG. 20 illustrates the assembly of FIG. 19 without a coverlay. The pads 200 and traces 202 may be formed of copper.

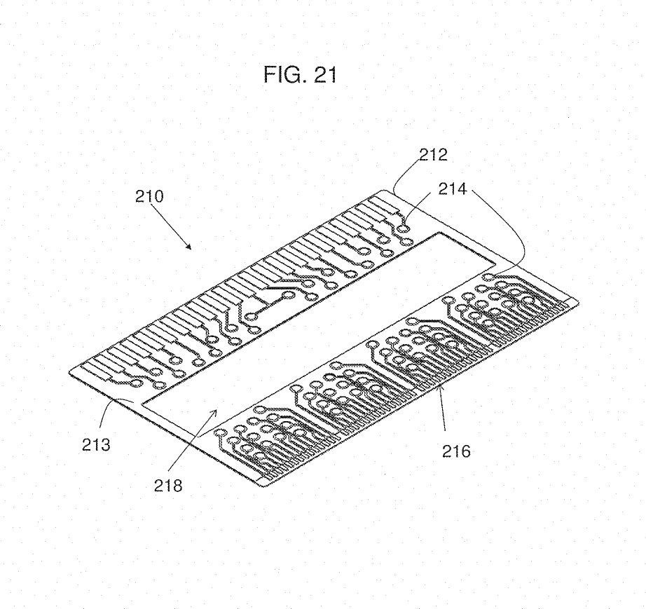

FIG. 21 illustrates a top view 210 of a flat preamp interposer 212, which may be used with the flat interconnected circuit and may be formed of polyimide, according to an exemplary embodiment. A top layer 213 may be formed on the polyimide as a coverlay. A copper layer may be exposed to form preamp contacts 214, e.g., concentric pads, for a flipchip-mount preamp. On a side of the flexure/suspension circuits, contacts 216, e.g., exposed copper, may be formed to connect with the pads or contacts of the edge-mounted flexure/suspension circuits. Optionally, an opening 218 may be formed, to accommodate at least a portion of the preamp 14. However, the arrangement of an exemplary embodiment described above is not limiting.

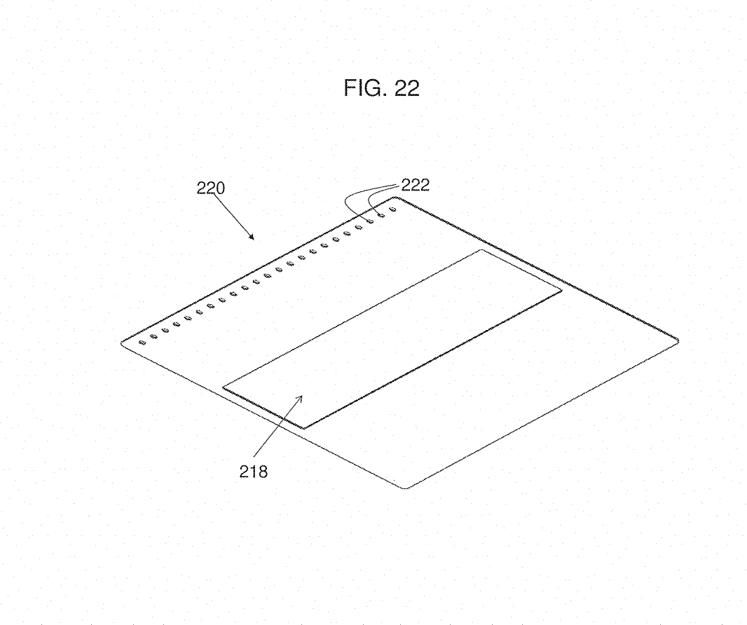

FIG. 22 illustrates a bottom view 220 of the flat preamp interposer 212 of FIG. 21, according to an exemplary embodiment. On a side of the main actuator circuit, contacts 222 may be formed to connect with the pads 192 of the flat preamp interposer. For example, an inner copper layer may be exposed to form the contacts 222.

FIG. 23 illustrates a bottom view 220 of the flat preamp interposer 212 of FIG. 21, according to an exemplary embodiment. On a side of the main actuator circuit, pads 230, e.g., rectangular pads, may be formed to connect with the pads 192 of the interposer circuit. For example, the pads 230 may be formed of stainless steel, to increase a total surface area for bonding, by either solder or ACF, with the pads 192 of the flat interposer circuit. On the side of the flexure/suspension circuits, a plate 232, e.g., a spacer may be placed, to maintain an even height of the flat preamp interposer. For example, the plate 232 may be formed of stainless steel.

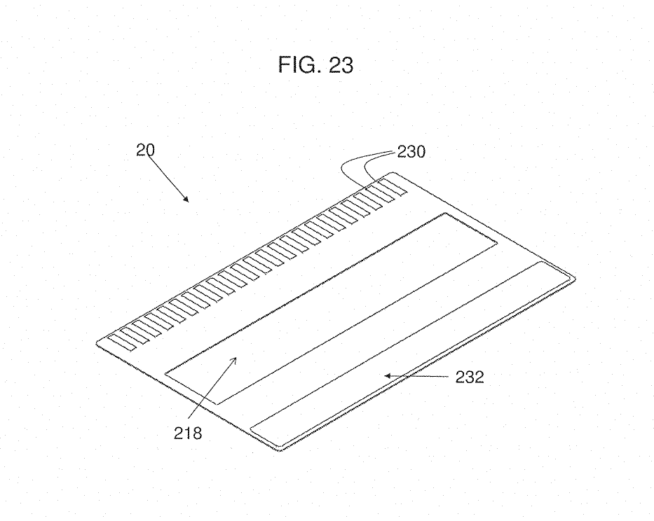

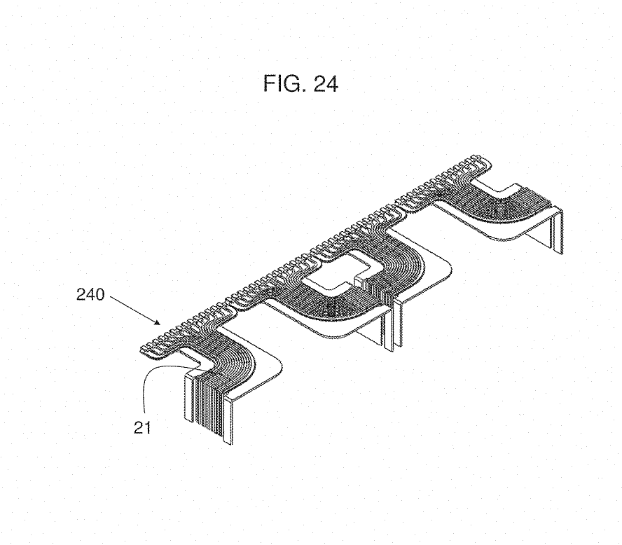

FIG. 24 illustrates a set of flexure/suspension circuits 21 which may be edge-mounted, according to an exemplary embodiment. Although only a portion of the flexure/suspension circuits 21 is illustrated for convenience of description, the flexure/suspension circuits 21 extend beyond the cutoff point shown in FIG. 24. Contacts 240, e.g., exposed copper, are formed on an edge of the flexure/suspension circuits 21 to connect to the contacts 216 of the preamp module 212. However, this is not limiting, and the contacts 240 may be used to edge mount directly to the preamp 14. Although FIG. 24 illustrates four flexure/suspension circuits 21, the number of flexure/suspension circuits 21 is not limiting.

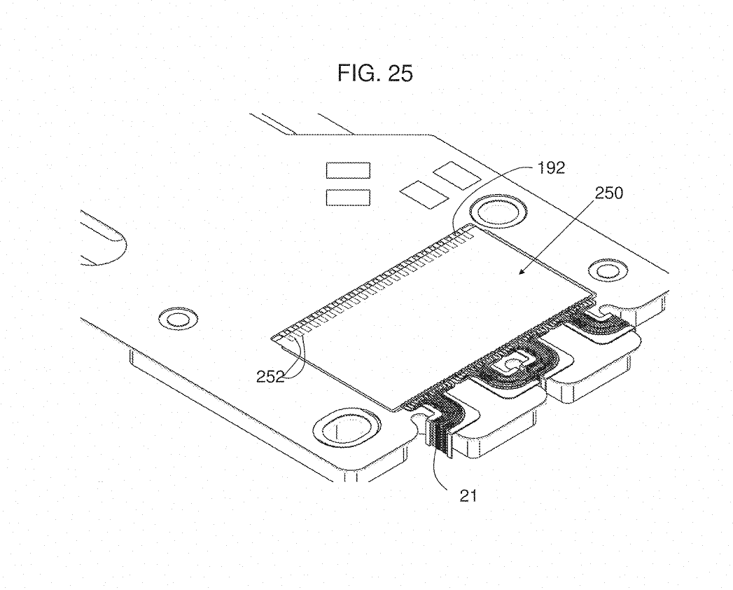

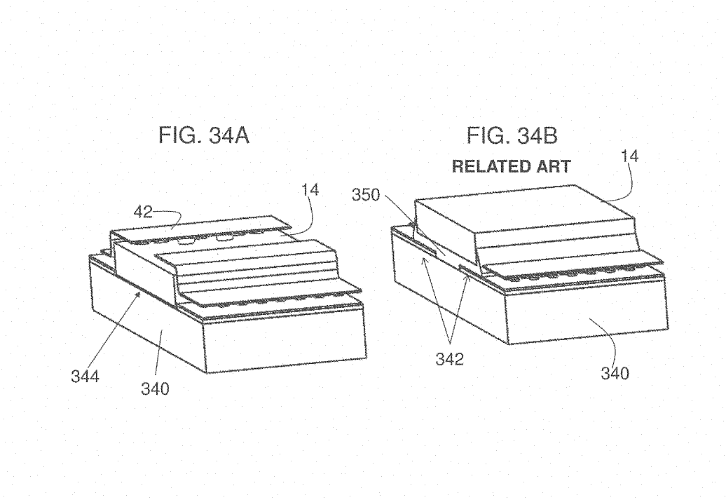

FIG. 25 illustrates a conductive film 250, e.g., an anisotropic conductive film, according to an exemplary embodiment, which is placed over at least a portion 252 of the copper pads 192 and provides electrical connection between the copper pads 192 and the preamp module 212, for example. One or more cutouts in conductive film 250 could be added to improve heat release of the preamp 14 to the metal stiffener 340 (FIG. 34A).

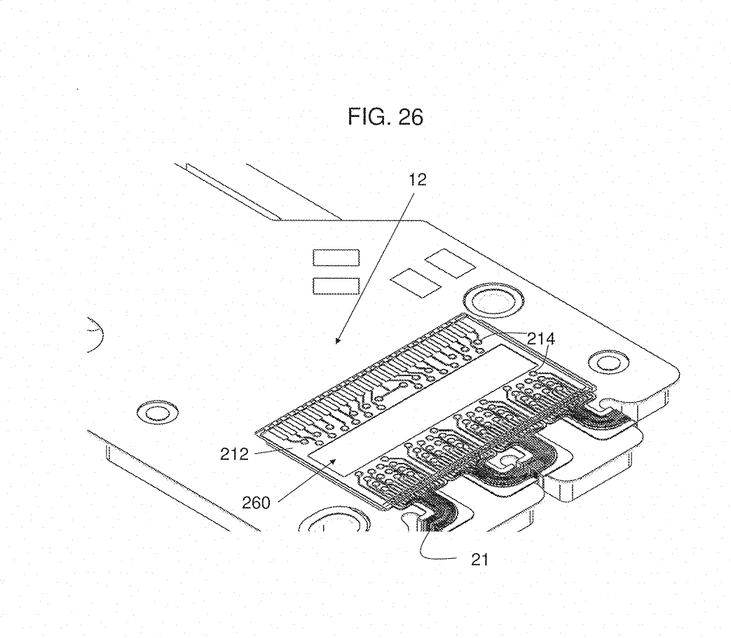

FIG. 26 illustrates the flat preamp interposer 212 attached to the main actuator circuit 12 via the conductive film 250, according to an exemplary embodiment. The preamp assembly may be done before or after the flat preamp interposer 212 is attached to the main actuator circuit. Reference numeral 260 indicates a portion of the conductive film 250 or metal stiffener 340 (if conductive film cutout is employed), exposed in the opening 218.

FIG. 27 illustrates a body 270 of the preamp 14, according to an exemplary embodiment.

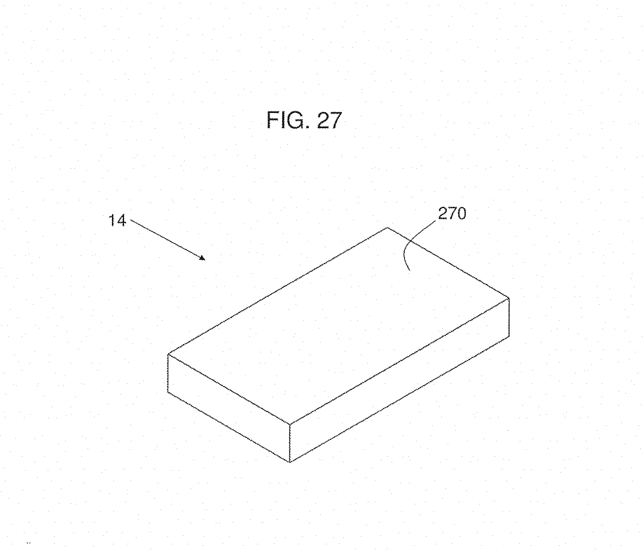

FIG. 28 illustrates a bottom side 280 of the body 270 of the preamp 14, according to an exemplary embodiment. A contact set 282 is disposed on the side of the main actuator circuit 12 and has bumps 284 for connecting to the preamp contacts 214 disposed on the preamp module 212 on the side of the main actuator circuit 12. A contact set 286 is disposed on the side of the flexure/suspension circuits 21 and has bumps 288 for connecting to the preamp contacts 214 disposed on the preamp module 212 on the side of the flexure/suspension circuits 21. Although FIG. 28 illustrates the contact set 282 having two groups of contacts and the contact set 286 having four groups of contacts, the number of group of contacts and the arrangement of contacts are not limiting.

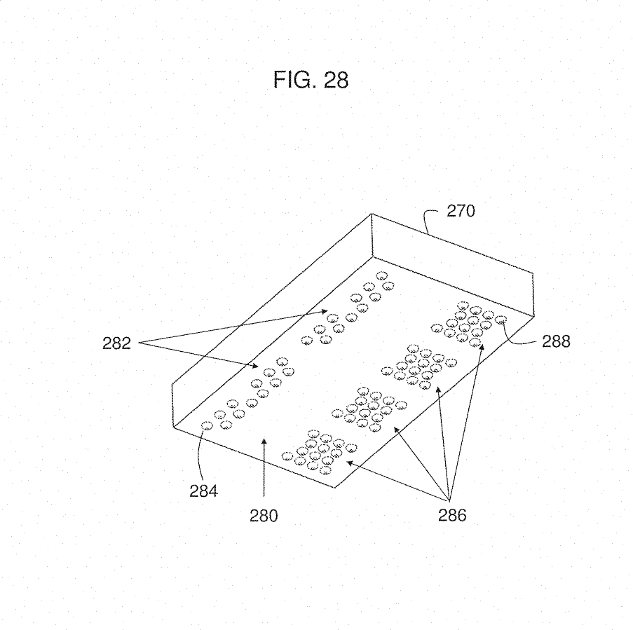

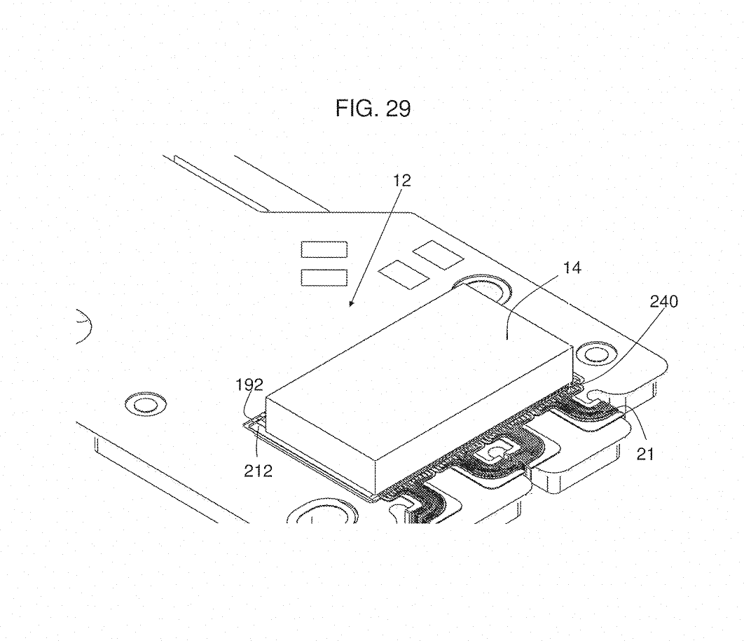

FIG. 29 illustrates the preamp 14 attached to the main actuator circuit 12 via the preamp module 212, according to an exemplary embodiment.

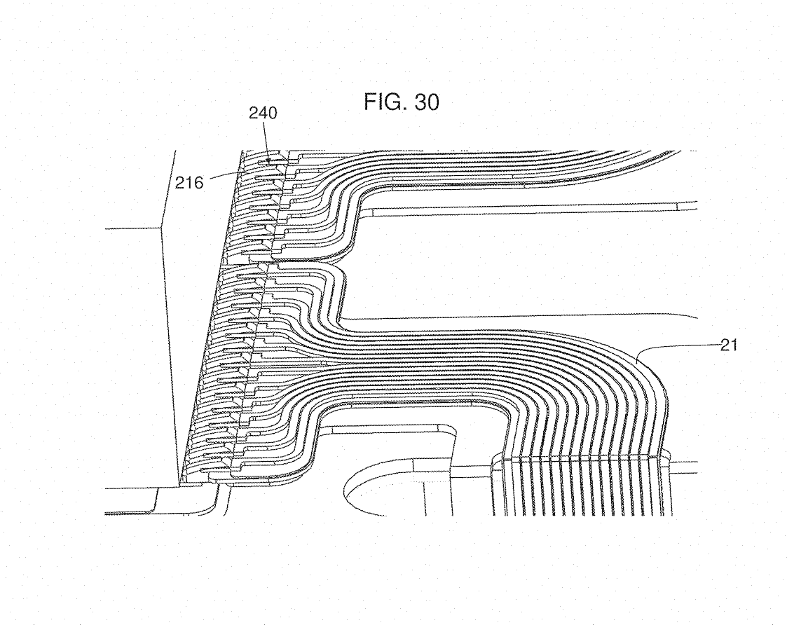

FIG. 30 illustrates the flexure/suspension circuits 21 edge-mounted to the preamp module 212, according to an exemplary embodiment. As shown, the contacts 240 of the flexure/suspension circuits are inserted into the spaces formed between the contacts 216 of the flat preamp interposer 212, so that the contacts 240 of the flexure/suspension circuits alternate with the contacts 216 of the flat preamp interposer 212 and make one on one contact with a corresponding contact 216 of the flat preamp interposer 212.

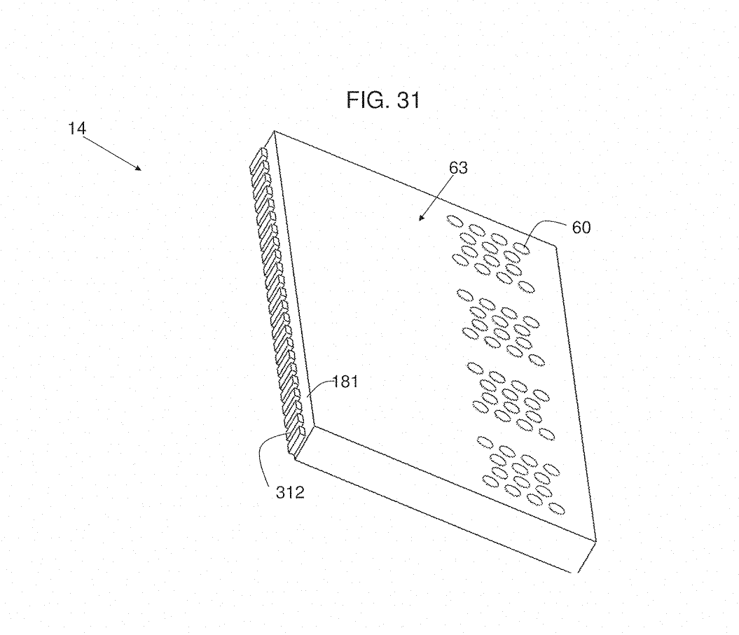

FIG. 31 illustrates an exemplary embodiment of the preamp 14 having contacts 60 disposed on the top surface 63 of the preamp 14, for connecting to the flexure/suspension circuits, and edge contacts 312 disposed on the first side surface 181 for connecting to the main actuator circuit 12. For example, the edge contacts 312 may be similar to the edge contacts 180 described above with reference to an exemplary embodiment of FIG. 18. Note that this type of preamp has conductive areas on the face and edge of the device.

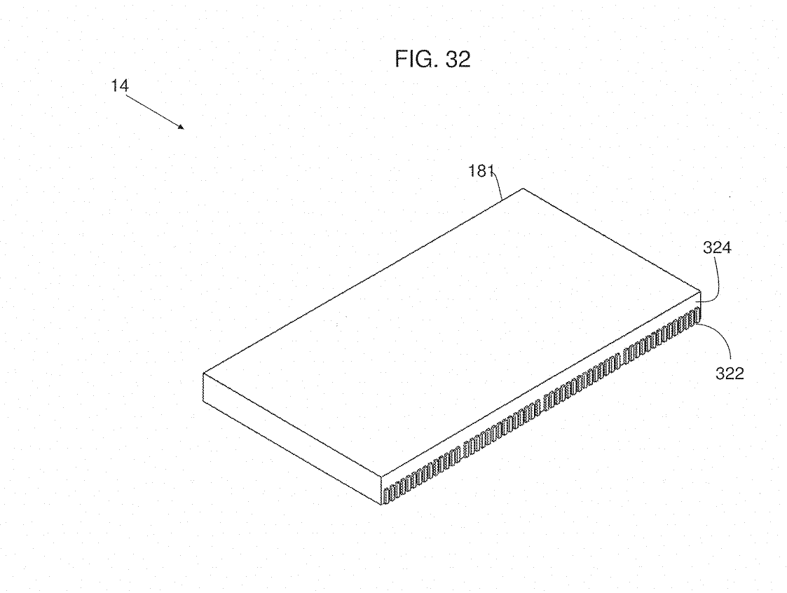

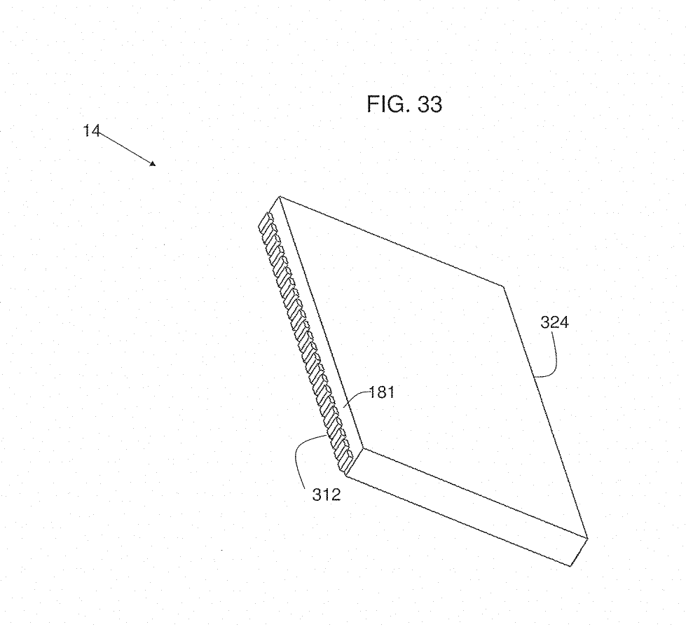

FIGS. 32 and 33 illustrate an exemplary embodiment of the preamp 14 having edge contacts 312, 322 disposed on first and second side surfaces 181, 324, for connecting to the flexure/suspension circuits and to the main actuator circuit 12, respectively. Note that this type of preamp has conductive areas on 2 opposing edges and is suitable for edge-mounted connections.

FIGS. 34A and 34B illustrate an assembly of an exemplary embodiment and of the related art, respectively. As shown in FIG. 34A, the preamp 14 according to an exemplary embodiment is disposed directly on a stiffener 340 which can be made of metal, e.g., aluminum. As shown in FIG. 34B, the preamp 14 according to the related art assembly is disposed on one or more additional layers 342 which are disposed on the stiffener 340. There is typically an underfill material 350 injected and cured to aid heat release and reduce stress of the solder bumps However, as shown by a reference numeral 344 in FIG. 34A, there are no such additional layers in an exemplary embodiment. Therefore, as compared to the related art, heat dissipation in an exemplary embodiment may be improved and underfill material 350 is eliminated.

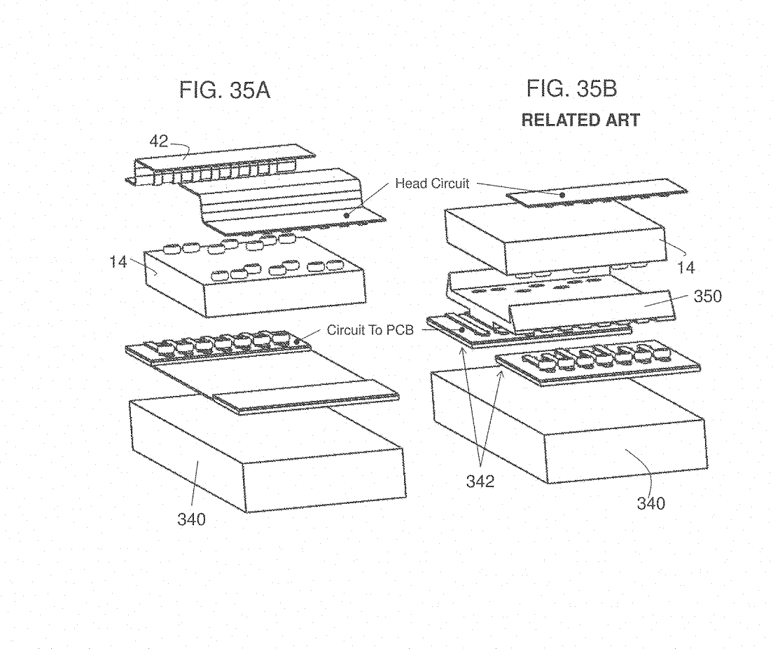

FIGS. 35A and 35B illustrate a detailed assembly of an exemplary embodiment and of related art, respectively. FIG. 35A shows direct connection of the suspension circuit 42 to the preamp 14 whereas related art FIG. 35B illustrates the flexure/suspension circuit not attached to the preamp.

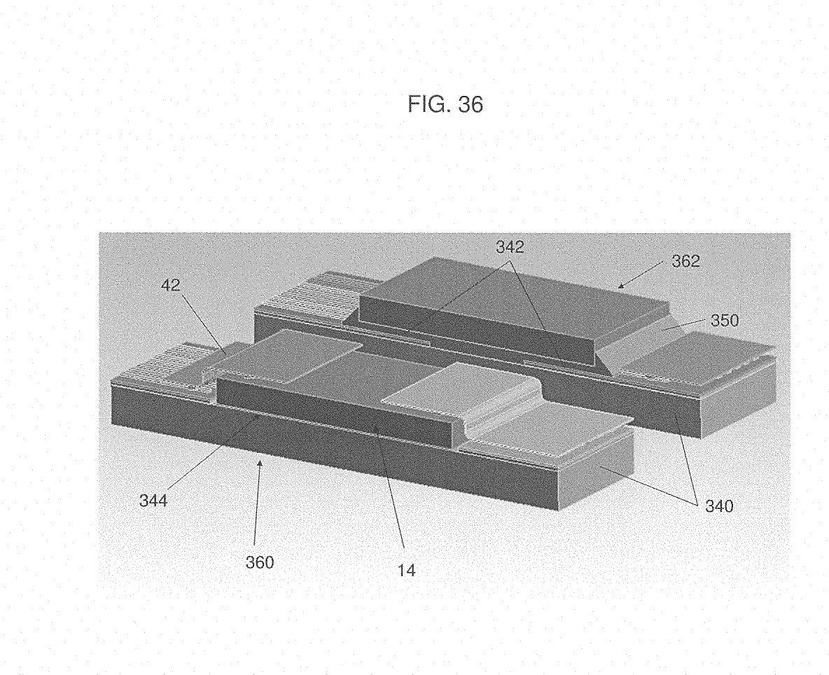

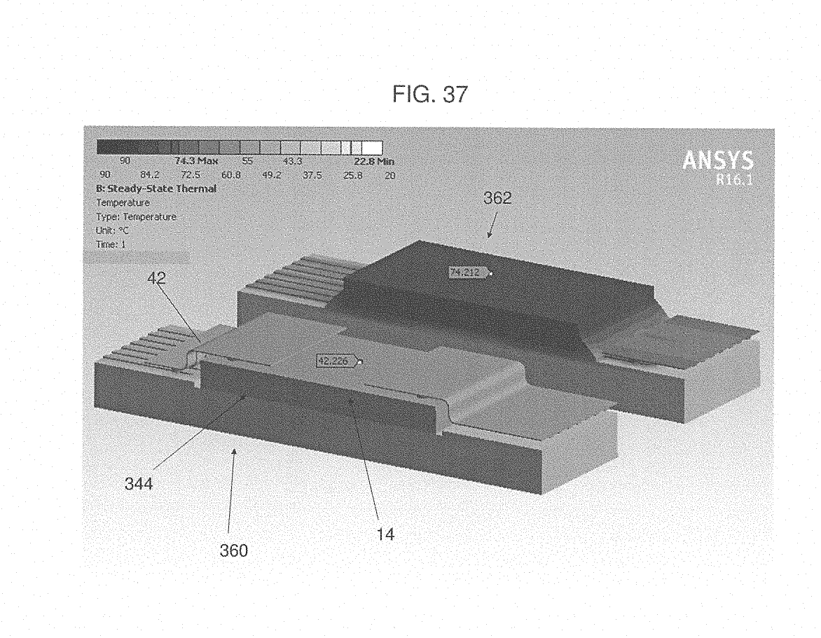

FIG. 36 illustrates the thermal simulation model 360 of an exemplary embodiment and the thermal simulation model 362 of the related art. As shown, the thermal simulation model 362 of the related art includes the additional layers 342 and underfill material 350, so that the preamp of the related art is not in direct contact with the stiffener 340. The thermal simulation model 360 of an exemplary embodiment does not include any layers between the preamp and the stiffener 340, i.e., the preamp of an exemplary embodiment is in direct contact with the stiffener 340.

The thermal simulation was performed under the following conditions: prescribe a fixed 25° C. temperature under stiffener; apply internal heat generation for preamp volume (1.5 W/mm³); apply thermal symmetry conditions; ignore convection.

FIG. 37 illustrates the thermal simulation results according to FIG. 36. As shown, the temperature of the preamp of the thermal simulation model 362 of the related art registered at approximately 74° C., while the temperature of the preamp of the thermal simulation model 360 of an exemplary embodiment registered at approximately 42° C.

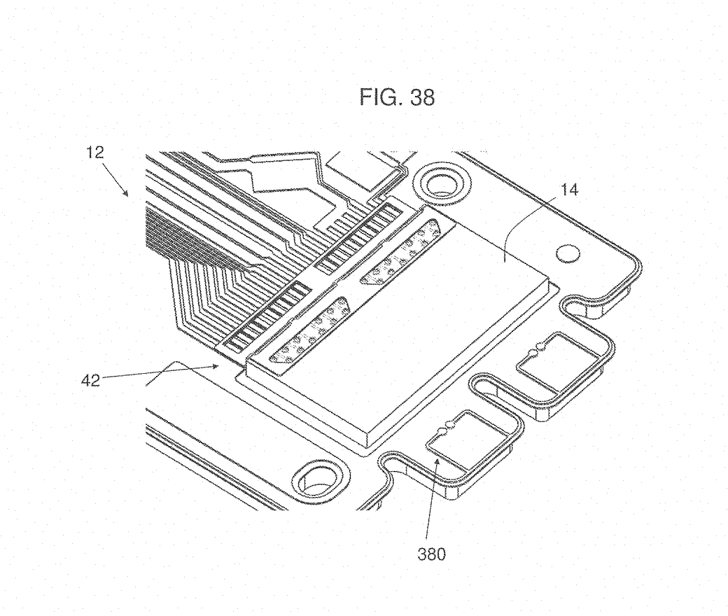

FIG. 38 illustrates DSA lines 380 formed in the main actuator circuit, according to an exemplary embodiment.

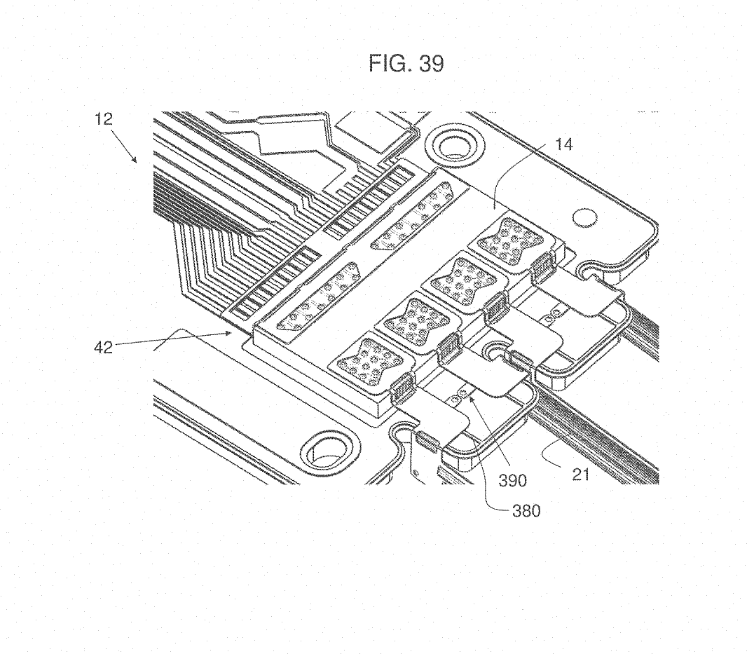

FIG. 39 illustrates the flexure/suspension circuits 21 provided with the copper flaps 390 to connect with the DSA lines 380, according to an exemplary embodiment.

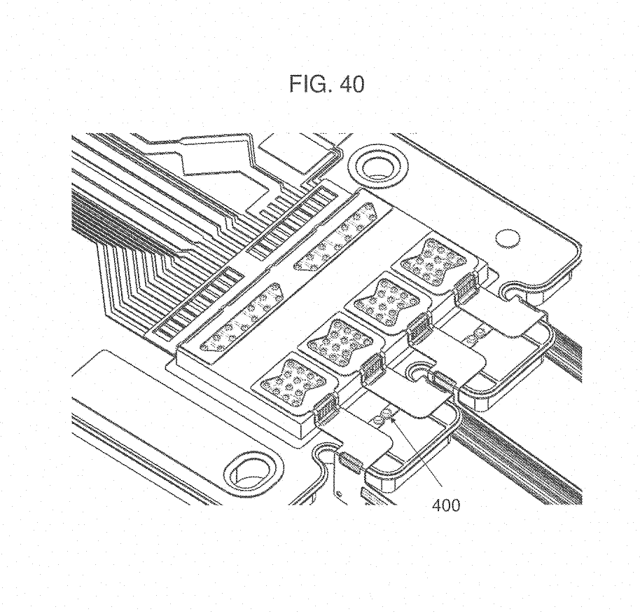

FIG. 40 illustrates the solder bumps 400 which electrically connect the DSA lines 380 with the flaps 390 of the flexure/suspension circuits 21, according to an exemplary embodiment.

As described above, an exemplary embodiment is directed to methods and apparatuses providing direct connections between the flexure/suspension circuit and one or more preamps. On the opposite end of the preamp(s) a separate interposer(s) may connect the main actuator circuit's circuitry to the preamp(s). This simplifies the main actuator circuit pad design connecting to the preamp(s).

This approach eliminates the need for a second set of conductive pads in the main actuator circuit since the flexure/suspension circuits are connected directly to the preamp(s).

Connection between the different components (main actuator circuit, interposer circuit, preamp(s), and flexure/suspension circuits) can be made using different methods: i.e. soldering, anisotropic conductive film, ultrasonic bonding etc.

The resulting reduction in the number of conductive pads in the main actuator circuit allows for simplification of the main actuator circuit design.

The direct connection between the preamp(s) and the flexure/suspension circuits reduces the potential for signal impedance discontinuity between the preamp(s) and the flexure/suspension circuit(s).

Since the preamp is mounted with the conductive pads facing up, the body of the preamp can be mounted directly to a metal part (stiffener) which is attached to the main actuator circuit resulting in improved thermal release/dissipation.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A head stack assembly (HSA) comprising:
a preamp having first contacts disposed on a first side and second contacts disposed on a second side which is opposite to the first side;
a main actuator circuit disposed proximate the first side of the preamp and having contacts configured to be electrically connected to the first contacts of the preamp; and
a flexure/suspension circuit disposed proximate the second side of the preamp and having flexure/suspension circuit contacts configured to be directly electrically connected to the second contacts of the preamp.

2. The HSA of claim 1, wherein the main actuator circuit includes a stiffener, and
the preamp is mounted in direct contact with the stiffener.

3. The HSA of claim 2, wherein the stiffener is formed of metal.

4. The HSA of claim 1, wherein the second contacts include one among contacts formed on a top surface of the preamp and contacts formed on a side surface of the preamp.

5. The HSA of claim 4, wherein the second contacts are formed on the top surface of the preamp,
the flexure/suspension circuit includes a body member which forms a plate-like contact region on an end portion of the flexure/suspension circuit, the flexure/suspension circuit contacts are formed on the plate-like contact region, and the plate-like contact region is placed over the top surface of the preamp for electrically connecting the flexure/suspension circuit contacts to the second contacts of the preamp.

6. The HSA of claim 5, wherein the second contacts are formed as conductive bumps and the flexure/suspension circuit contacts are formed as conductive openings which are laid over and matched with the conductive bumps of the preamp, for electrically connecting the preamp and the flexure/suspension circuit.

7. The HSA of claim 4, wherein the second contacts include edge contacts formed on the side surface of the preamp,
the flexure/suspension circuit includes individual flexure ends,
the flexure/suspension circuit contacts are formed on the individual flexure ends, respectively, and
the flexure/suspension circuit contacts are matched with the edge contacts of the preamp, for electrically connecting the preamp and the flexure/suspension circuit.

8. The HSA of claim 1, further including an interposer circuit configured to provide electrical connectivity between the preamp and the main actuator circuit.

9. The HSA of claim 8, wherein the main actuator circuit includes contacts disposed proximate the preamp,
the interposer circuit includes a body having an upper plate configured to be disposed on the preamp and a lower plate configured to be disposed on the main actuator circuit,
the upper plate includes upper contacts configured to electrically connect to the first contacts of the preamp, and
the lower plate includes lower contacts configured to electrically connect to the contacts of the main actuator circuit.

10. The HSA of claim 9, wherein the contacts of the main actuator circuit and the first contacts of the preamp are formed as conductive bumps, and
the upper contacts and the lower contacts of the interposer circuit are formed as conductive openings which are laid over and matched to the conductive bumps of the main actuator circuit and the preamp.

11. The HSA of claim 9, wherein the contacts of the main actuator circuit are formed as conductive pads,
the first contacts of the preamp are formed as conductive bumps,
the upper contacts of the interposer circuit are formed as upper conductive openings,
the lower contacts of the interposer circuit are formed as lower conductive pads, and
the upper conductive openings of the interposer circuit are matched with the conductive bumps of the preamp and the lower conductive pads of the interposer circuit are bonded with the conductive pads of the main actuator circuit.

12. The HSA of claim 8, wherein the main actuator circuit includes contacts disposed proximate the preamp, and
the interposer circuit includes edge contacts disposed on a side surface of the preamp for electrically connecting to the contacts of the main actuator circuit.

13. The HSA of claim 1, further comprising a preamp module which is disposed on the main actuator circuit and to which the preamp is mounted.

14. The HSA of claim 13, wherein the preamp module includes:
a first side and a second side which respectively correspond to the first side and the second side of the preamp,
first preamp module contacts formed on the first side of the preamp module, for electrically connecting the main actuator circuit to the preamp, and
second preamp module contacts formed on the second of the preamp module, for electrically connecting the flexure/suspension circuit to the preamp.

15. The HSA of claim 14, wherein the main actuator circuit includes contacts formed as conductive pads and disposed proximate the preamp, and
a layer of conductive material is placed over the contacts of the main actuator circuit underneath the preamp, for electrically connecting the contacts of the main actuator circuit to the first contacts of the preamp.

16. The HSA of claim 14, wherein the preamp includes a body which houses the preamp and includes a bottom surface disposed proximate the preamp module,
the first contacts of the preamp are formed as conductive bumps on the bottom surface proximate the first side of the preamp, for electrically connecting the contacts of the main actuator circuit to the first contacts of the preamp via the preamp module, and
the second contacts of the preamp are formed as conductive bumps on the bottom surface proximate the second side of the preamp, for electrically connecting the flexure/suspension circuit contacts to the preamp via the preamp module.

17. The HSA of claim 14, wherein the main actuator circuit includes contacts formed as conductive pads and disposed proximate the preamp,
the flexure/suspension circuit includes individual flexure ends,
the flexure/suspension circuit contacts are formed on the individual flexure ends, respectively,
a portion of the first preamp module contacts is formed as conductive pads proximate the main actuator circuit, for electrically connecting to the conductive pads of the main actuator circuit, and a portion of the second preamp module contacts is formed as conductive pads proximate the flexure/suspension circuit, for electrically connecting to the individual flexure ends.
